(19) United States
(12) Patent Application Publication
(10) Pub. No.: US 2026/0307083 A1
(43) Pub. Date: Oct. 8, 2026

(54) INSULATOR AND WET ELECTROSTATIC PRECIPITATOR HAVING THE SAME

(71) Applicant: CSK Inc., Yongin-si, Gyeonggi-do (KR)

(72) Inventors: Yun Soo Choi, Yongin-si, Gyeonggi-do (KR); Chan Kyoo Ko, Yongin-si, Gyeonggi-do (KR); Pil-Hyong Lee, Yongin-si, Gyeonggi-do (KR); Young-Kun Kim, Yongin-si, Gyeonggi-do (KR); Hyoki Min, Yongin-si, Gyeonggi-do (KR); Hyuna Shin, Yongin-si, Gyeonggi-do (KR); Jeong-Keun Lee, Yongin-si, Gyeonggi-do (KR)

(21) Appl. No.: 19/482,103

(22) PCT Filed: May 7, 2024
(86) PCT No.: PCT/IB2024/054437

§ 371 Date: Nov. 6, 2025

(30) Foreign Application Priority Data
May 10, 2023 (KR) 10-2023-0060782

(51) Int. Cl. B03C 3/70; B03C 3/16

(52) U.S. Cl. CPC B03C 3/70; B03C 3/16

(57) ABSTRACT

An insulation device has an insulator passing through an insulation device cover such that one side of the insulator is disposed in an insulating area and the other side thereof is disposed outside the insulation device cover. A portion of an electrode connecting member which extends from an interior of a wet electrostatic precipitator passes through the insulator. The insulator extends to the outside of the insulation device cover to insulate a portion of the electrode connecting member, wherein the insulation device cover is configured to spray, onto the insulator, at least one of an insulator contamination prevention fluid for preventing contamination of a surface of the insulator, an insulator cleaning fluid for cleaning a surface of the insulator, and an insulator drying fluid for drying a surface of the insulator.

### CROSS-REFERENCE OF RELATED APPLICATION

This application is a Section 371 National Stage Application of International Application No. PCT/IB 2024/054437, filed May 7, 2024, and published as WO 2024/231835 A1 on Nov. 14, 2024, the content of which is hereby incorporated by reference in its entirety and which claims priority of Korean Application No. 10-2023-0060782, filed May 10, 2023.

### FIELD

The present disclosure relates to an insulation device and a wet electrostatic precipitator having the same.

### BACKGROUND

Waste gases discharged from an electronics industry process for manufacturing electronic products such as semiconductors, display devices, solar cells, or organic light emitting diodes contain acidic components, moisture, dust, etc. These waste gases generally have characteristics such as toxicity, corrosiveness, and explosiveness, and are treated and discharged by a scrubber system using plasma method, combustion oxidation method, electric heating oxidation method, or chemical adsorption method. The plasma method generates a high-temperature plasma to decompose and treat the waste gas, and the combustion oxidation method is the most commonly used method for waste gas treatment, which includes heating and decomposing the waste gas with a high temperature flame using LNG and an oxidizing agent.

In these waste gas treatment methods, in order to capture particulates generated as reaction byproducts during the waste gas decomposition process by the plasma or flame, a water treatment process is performed by letting the waste gas pass through a water treatment module which sprays water into the waste gas. In addition, in the waste gas treatment methods, an electrostatic precipitating process of passing the waste gas through an electric precipitator is performed together with the water treatment process, in order to achieve more efficient capture of the particulates. The electrostatic precipitator charges and captures the particulates contained in the waste gas using corona discharge generated between a discharge electrode and a precipitation electrode.

Meanwhile, the discharge electrode of the electrostatic precipitator is connected to a high voltage power source by an electrode connecting member, and the electrode connecting member is insulated by an insulator. Conventionally, in an electric precipitator, the entire electrode connection member was insulated with an insulator. In addition, in a conventional electrostatic precipitator, particulates or conductive gases that had not been removed from a waste gas were accumulated on a surface of the insulator, contaminating the surface of the insulator. When the surface of the insulator is contaminated by accumulation of the particulates or conductive gases thereon, insulation breakdown occurs through the contaminated surface of the insulator, resulting in a high voltage short circuit, and the operation of the electrostatic precipitator stops. Conventionally, in the electric precipitator, the operating time of the electrostatic precipitator was not long enough as desired due to this insulation breakdown and high voltage short circuit caused by the contamination of the surface of the insulator.

The discussion above is merely provided for general background information and is not intended to be used as an aid in determining the scope of the claimed subject matter. The claimed subject matter is not limited to implementations that solve any or all disadvantages noted in the background.

### SUMMARY

Embodiments of the present invention have been invented in light of the above background to provide an insulation device and a wet electrostatic precipitator having the same capable of minimizing contamination of a surface of an insulator that insulates a portion of an electrode connecting member connected to a discharge electrode and a power source.

According to an aspect of the invention, there is provided an insulation device, comprising: an insulation device body forming an insulating area, the insulation device body being connected to a wet electrostatic precipitator such that one open side of the insulating area is in communication with an interior of the wet electrostatic precipitator; an insulation device cover connected to the insulation device body to close the other open side of the insulating area; and an insulator passing through the insulation device cover such that one side of the insulator is disposed in the insulating area and the other side thereof is disposed outside the insulation device cover, a portion of an electrode connecting member which extends from the interior of the wet electrostatic precipitator to the insulating area passing through the insulator, the insulator extending to the outside of the insulation device cover to insulate a portion of the electrode connecting member, wherein the insulation device cover is configured to spray, onto the insulator, at least one of an insulator contamination prevention fluid for preventing contamination of a surface of the insulator, an insulator cleaning fluid for cleaning a surface of the insulator, and an insulator drying fluid for drying a surface of the insulator.

In another aspect, there is provided an insulation device, wherein the insulation device cover comprises a first fluid spray cover through which the insulator passes, the first fluid spray cover being configured to spray at least one of the insulator contamination prevention fluid, the insulator cleaning fluid, and the insulator drying fluid along a circumference of the insulator, in an angle with a longitudinal direction of the insulator.

In another aspect, there is provided an insulation device which the first fluid spray cover comprising: a first fluid supply path connected to an insulator contamination prevention fluid supply source, an insulator cleaning fluid supply source, and an insulator drying fluid supply source; a fluid flowing area connected to the first fluid supply path, at least one of the insulator contamination prevention fluid, the insulator cleaning fluid, and the insulator drying fluid supplied through the first fluid supply path flowing in the fluid flowing area; and a fluid spray outlet disposed at the circumference of the insulator so as to be in communication with the fluid flowing area, the fluid spray outlet being configured such that at least one of the insulator contamination prevention fluid, the insulator cleaning fluid, and the insulator drying fluid is sprayed therethrough.

In another aspect, there is provided an insulation device, wherein the first fluid supply path is formed to be parallel to a virtual line passing a center of a transverse cross-section of the insulator and to be spaced apart from the virtual line to one side or the other side, the transverse cross-section being a cross-section of the insulator perpendicular to the longitudinal direction of the insulator.

In another aspect, there is provided an insulation device, wherein the size of a transverse cross-section of the fluid flowing area, which is a cross-section of the fluid flowing area perpendicular to the longitudinal direction of the insulator, decreases towards the fluid spray outlet.

In another aspect, there is provided an insulation device which the first fluid spray cover comprising: a first spray cover main part including a first through-hole through which the insulator passes, the first fluid supply path, and a first flowing area forming part spaced apart from the first through-hole in a radial direction and surrounding the first through-hole; and a first spray cover auxiliary part including a fluid spray outlet opening which forms the fluid spray outlet between one end of the first flowing area forming part in the longitudinal direction of the insulator, and a second flowing area forming part extending from the fluid spray outlet opening towards the first spray cover main part so as to form the fluid flowing area together with the first flowing area forming part.

In another aspect, there is provided an insulation device which the insulation device cover further comprising a second fluid spray cover connected to the first fluid spray cover and the insulation device body to close the other open side of the insulating area together with the first fluid spray cover, the insulator passing through the second fluid spray cover, the second fluid spray cover being configured to spray at least one of the insulator contamination prevention fluid, the insulator cleaning fluid, and the insulator drying fluid around the insulator, in an angle with a circumferential direction of the insulator.

In another aspect, there is provided an insulation device which the second fluid spray cover comprising: a second fluid supply path connected to an insulator contamination prevention fluid supply source, an insulator cleaning fluid supply source, and an insulator drying fluid supply source; a fluid flowing path connected to the second fluid supply path, at least one of the insulator contamination prevention fluid, the insulator cleaning fluid, and the insulator drying fluid supplied through the second fluid supply path flowing in the fluid flowing path; and a plurality of fluid spraying paths connected to the fluid flowing path and disposed along the circumference of the insulator, the plurality of fluid spraying paths spraying at least one of the insulator contamination prevention fluid, the insulator cleaning fluid, and the insulator drying fluid.

In another aspect, there is provided an insulation device, wherein the fluid spraying paths extend towards the insulator in an angle with the circumferential direction of the insulator.

In another aspect, there is provided an insulation device which the second fluid spray cover comprising: a second spray cover main part including a second through-hole through which the insulator passes, the second fluid supply path, and a flowing path forming part spaced apart from the second through-hole in a radial direction and surrounding the second through-hole; and a second spray cover auxiliary part including a third through-hole which the insulator passes through and the plurality of fluid spraying paths are formed to be in communication with, the second spray cover auxiliary part forming the fluid flowing path together with the flowing path forming part.

In another aspect, there is provided a wet electrostatic precipitator, comprising: a precipitator body which is grounded and formed with a gas processing area, wherein a waste gas containing particulates enters and flows in the gas processing area and a purified gas, which is the waste gas from which the particulates have been removed, is discharged from the gas processing area; a discharge electrode disposed in the gas processing area to be spaced apart from the precipitator body; an insulation device formed with an insulating area and connected to the precipitator body such that one open side of the insulating area is in communication with the gas processing area; and an electrode connecting member whose one side is connected to the discharge electrode and the other side passes through the insulation device via a portion of the gas processing area and the insulating area, the electrode connecting member extending outside of the insulation device to be connected to a power source, wherein the insulation device comprises an insulator, which a portion of the electrode connecting member passes through, to insulate the portion of the electrode connecting member, and wherein the insulation device is configured to spray, onto the insulator, at least one of an insulator contamination prevention fluid for preventing contamination of a surface of the insulator, an insulator cleaning fluid for cleaning a surface of the insulator, and an insulator drying fluid for drying a surface of the insulator.

In another aspect, there is provided a wet electrostatic precipitator which the insulation device further comprising: an insulation device body formed with the insulating area; and an insulation device cover connected to the insulation device body to close the other open side of the insulating area, wherein the insulator passes through the insulation device cover so that one side is disposed in the insulating area and the other side is disposed outside of the insulation device cover, and wherein the insulation device cover is configured to spray, onto the insulator, at least one of the insulator contamination prevention fluid, the insulator cleaning fluid, and the insulator drying fluid.

In another aspect, there is provided a wet electrostatic precipitator which further comprises a controller for controlling the supply of the insulator contamination prevention fluid, the insulator cleaning fluid, and the insulator drying fluid to the insulation device cover, wherein the controller controls: in a precipitation mode where the particulates contained in the waste gas is precipitated in the wet electrostatic precipitator, the insulator contamination prevention fluid to be sprayed onto a surface of the insulator through the insulation device cover; in an insulator cleaning mode where a surface of the insulator is cleaned, the insulator contamination prevention fluid and the insulator cleaning fluid to be sprayed onto a surface of the insulator through the insulation device cover while blocking an electrical connection between the power source and the discharge electrode; and in an insulator drying mode where a surface of the insulator is dried, the power source and the discharge electrode to be electrically connected with each other after the insulator drying fluid is sprayed onto a surface of the insulator.

According to the embodiments of the present invention, the insulator contamination prevention fluid is sprayed on the surface of the insulator that insulates a portion of the electrode connecting member connected to the discharge electrode and the power source, thereby preventing contamination of the surface of the insulator.

In addition, according to the embodiments of the present invention, periodically or non-periodically, the insulator cleaning fluid, together with the insulator contamination prevention fluid, is sprayed on the surface of the insulator so that the surface of the insulator is dried after cleaning, which achieves an effect of minimizing the contamination of the surface of the insulator.

Additionally, according to the embodiments of the present invention, the operating time of the wet electrostatic precipitator can be increased by minimizing insulation breakdown and high voltage short circuit due to contamination of the surface of the insulator in the wet electrostatic precipitator.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The objects and features of the present disclosure will become apparent from the following description of embodiments, given in conjunction with the accompanying drawings, in which:

FIG. 1 is a perspective view of a wet electrostatic precipitator according to an embodiment of the invention.

FIG. 2 is a cross-sectional view according to the line I-I′ of FIG. 1.

FIG. 3 is a perspective view of an insulation device according to an embodiment of the invention.

FIG. 4 is a cross-sectional view according to the line II-II′ of FIG. 3, illustrating first to fourth supply pipes connecting first and second fluid supply paths and fluid supply sources, and a controller.

FIG. 5 is a cross-sectional view according to the line I-I′ of FIG. 4.

FIG. 6 is a cross-sectional view according to the line IV-IV′ of FIG. 4.

FIGS. 7 and 8 are operational diagrams of the insulation device according to an embodiment of the invention and the wet electrostatic precipitator having the same, showing a precipitation mode.

FIG. 9 is an operational diagram of the insulation device according to an embodiment of the invention and the wet electrostatic precipitator having the same, depicting an insulator cleaning mode.

FIG. 10 is an operational diagram of the insulation device according to an embodiment of the invention and the wet electrostatic precipitator having the same, illustrating an insulator drying mode.

### DETAILED DESCRIPTION

Hereinafter, specific embodiments for implementing the technical concept of the invention are described in detail with reference to the accompanying drawings.

Besides, in describing the invention, detailed descriptions on certain features or functions known in the art may be omitted if they are considered to render the gist of the invention vague.

It shall be understood that, as employed herein, the statement that an element is “connected to,” “supported by,” or “supplied to” another element may mean either that the element is directly connected to, supported by, or supplied to another element or that one or more intermediate parts are present therebetween.

The terms as employed herein are intended only to describe the specific embodiments of the invention, not to limit the disclosed concept of the invention. A singular expression is used to cover the corresponding plural expression, unless expressed otherwise in the context.

Further, as employed herein, directional phrases such as upper, lower, side and derivatives thereof are described with reference to the orientation shown in the drawings and may be expressed differently if the orientation is changed. Likewise, in the accompanying drawings, some components are exaggerated, omitted, or schematically illustrated, and the size of each component does not entirely reflect the actual size.

Further, as employed herein, terms including ordinal numbers, such as first and second, may be used to describe various features, but the features are not limited by the terms. These terms are only used to distinguish one element from the other.

As employed herein, the term “comprise” or “include” shall specify particular characteristics, areas, essence, steps, operations, elements and/or components, but shall not exclude existence or addition of other characteristics, areas, essence, steps, operations, elements, components and/or ground.

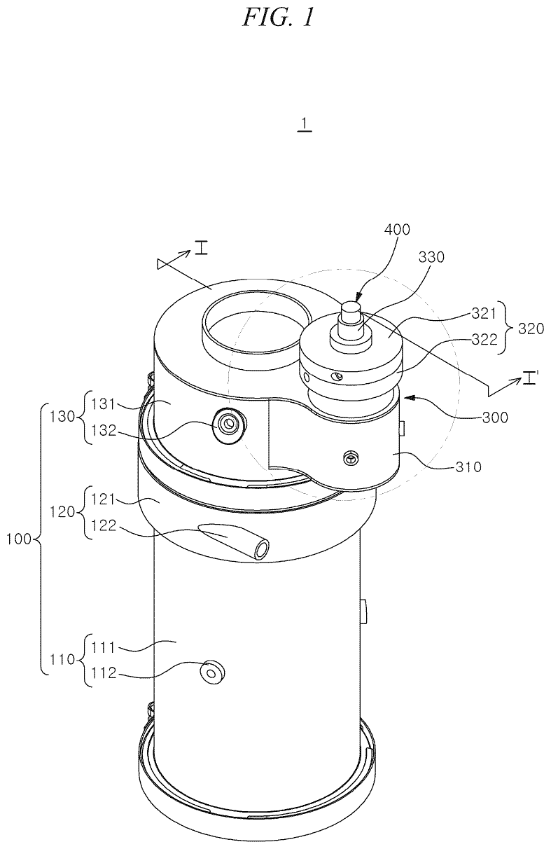

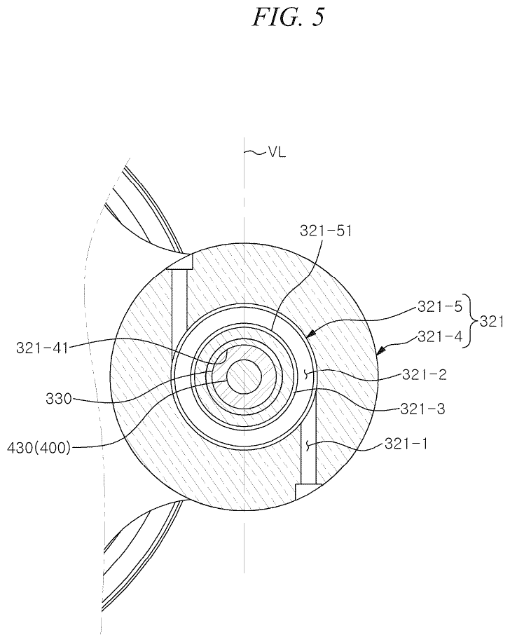

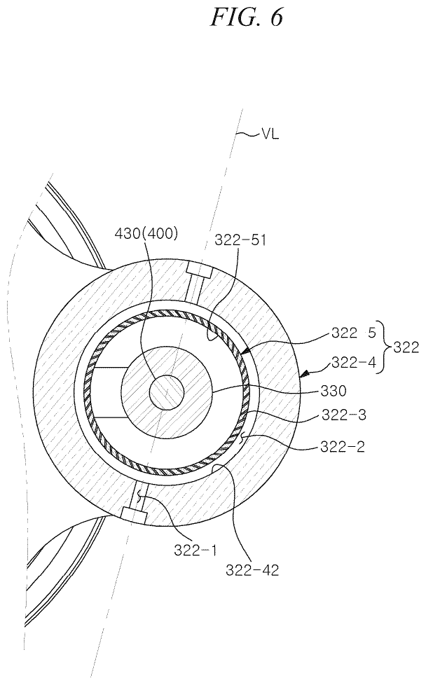

Hereinafter, with reference to FIGS. 1 to 6, specific features of an insulation device according to an embodiment of the invention and a wet electrostatic precipitator having the same are described. The wet electrostatic precipitator 1 is for charging particulates contained in a waste gas using corona discharge to capture the charged particulates, thereby removing them from the waste gas. While the particulates contained in the waste gas that has entered the wet electrostatic precipitator 1 flow inside the wet electrostatic precipitator 1 with the waste gas, they may be charged by corona discharge and captured on an inner surface of the wet electrostatic precipitator 1. The particulates captured on the inner surface of the wet electrostatic precipitator 1 may be discharged from the wet electrostatic precipitator 1 by a particulate discharge fluid such as water. The wet electrostatic precipitator 1 may comprise a precipitator body 100, a discharge electrode 200, an insulation device 300, an electrode connecting member 400, and a controller 500.

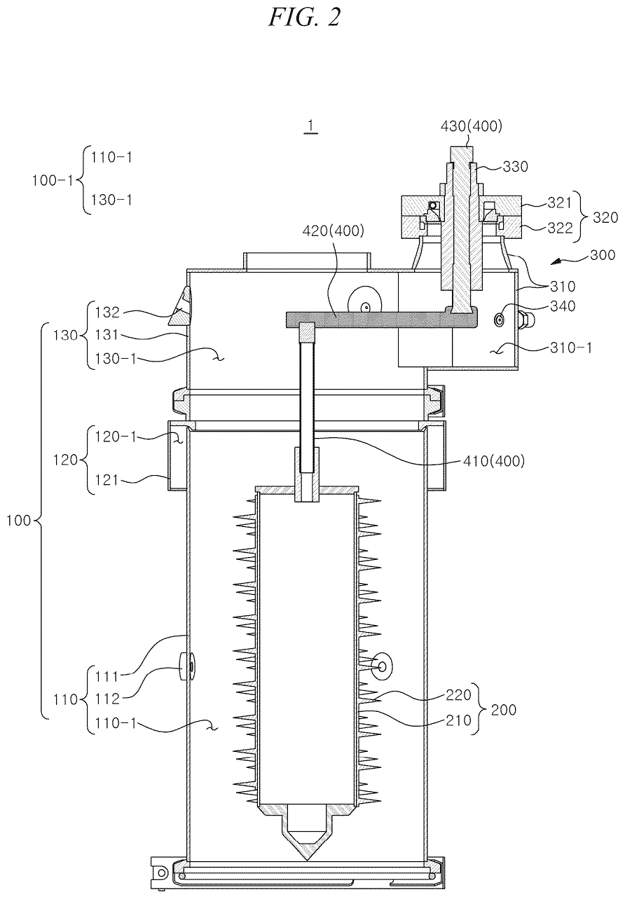

According to FIGS. 1 and 2, the waste gas containing the particulates may enter the precipitator body 100 and flow therein, and a purified gas, which is the waste gas from which the particulates have been removed, may be discharged threrfrom. In the precipitator body 100, a gas processing area 100-1 may be formed. The waste gas may enter the gas processing area 100-1 through one open side of the gas processing area 100-1 to flow in the gas processing area 100-1. Further, the purified gas, which is the waste gas from which the particulates have been removed while flowing in the gas processing area 100-1, may be discharged from the gas processing area 100-1 through the other open side thereof. For example, the precipitator body 100 may have a hollow tubular shape forming the gas processing area 100-1, and the gas processing area 100-1 may have open lower and upper parts. In the gas processing area 100-1, the discharge electrode 200 and a portion of the electrode connecting member 400 may be disposed. In addition, the insulation device 300 may be connected to the precipitator body 100 such that the gas processing area 100-1 is in communication with an interior of the insulation device 300. The precipitator body 100 is grounded and the particulates, which are included in the waste gas charged by corona discharge by the discharge electrode 200, may be precipitated on the precipitator body 100. In other words, at least a portion of the precipitator body 100 may form a precipitator electrode or a precipitator substrate. The precipitator body 100 may comprise a precipitation unit 110, a particulate discharge fluid supply unit 120, and a discharge guide unit 130.

The waste gas containing particulates may enter the precipitation unit 110 and flow therein, the particulates contained in the waste gas may be charged by corona discharge by the discharge electrode 200 and the charged particulates may be precipitated on the inner surface of the precipitation unit 110. The precipitation unit 110 may be connected to a waste gas supply pipe or the like such that the waste gas containing the particulates may be introduced thereinto. In the precipitation unit 110, there may be formed a precipitating area 110-1 which forms a portion of the gas processing area 100-1, where the waste gas containing the particulates enters and the particulates are precipitated while the waste gas flowing therein. For example, the precipitation unit 110 may have a hollow tubular shape that forms the precipitating area 110-1, and the precipitating area 110-1 may have open lower and upper parts. The discharge electrode 200 may be disposed in the precipitating area 110-1 so that the particulates contained in the waste gas flowing in the precipitating area 110-1 are charged. Additionally, a portion of the electrode connecting member 400 may be disposed in the precipitating area 110-1. The precipitation unit 110 may comprise a precipitating area forming member 111 and an electrode cleaning fluid spray nozzle 112.

The precipitating area forming member 111 has a tubular shape with its one side and the other side open to form the precipitating area 110-1. The precipitating area forming member 111 may be connected to the waste gas supply pipe or the like and to the particulate discharge fluid supply unit 120. The electrode cleaning fluid spray nozzle 112 may be connected to an electrode cleaning fluid supply source and may spray the electrode cleaning fluid to the discharge electrode 200 disposed in the precipitating area 110-1 when cleaning of the discharge electrode 200 is required. For example, the electrode cleaning fluid sprayed from the electrode cleaning fluid spray nozzle 112 may be water. In this case, the electrode cleaning fluid supply source may be identical to an insulator cleaning fluid supply source which is to be described below.

The particulate discharge fluid supply unit 120 may be connected to the precipitation unit 110 to supply the particulate discharge fluid to the inner surface of the precipitation unit 110. The particulates precipitated on the inner surface of the precipitation unit 110 may be discharged from the precipitation unit 110 by the particulate discharge fluid supplied to the inner surface of the precipitation unit 110 through the particulate discharge fluid supply unit 120. A particulate discharge fluid supply area 120-1 may be formed in the particulate discharge fluid supply unit 120. The particulate discharge fluid supply area 120-1 may be disposed to surround the precipitation unit 110 and may be in communication with the precipitating area 110-1. For example, the particulate discharge fluid supply area 120-1 may be disposed to surround an upper part of the precipitation unit 110 and may be in communication with the precipitating area 110-1. The particulate discharge fluid may be supplied from a particulate discharge fluid supply source to the particulate discharge fluid supply area 120-1. For instance, the particulate discharge fluid may be water. In this case, the particulate discharge fluid supply source may be identical to an insulator cleaning fluid supply source which is to be described below. The particulate discharge fluid supply unit 120 may comprise a supply area forming member 121 and a particulate discharge fluid supply path 122.

The supply area forming member 121 may surround the precipitation unit 110 to form the particulate discharge fluid supply area 120-1 therebetween. For example, the supply area forming member 121 may surround a circumference of the upper part of the precipitation unit 110 to form the particulate discharge fluid supply area 120-1. In addition, the supply area forming member 121 may be connected to the discharge guide unit 130 in a state where an end of the supply area forming member 121 is disposed apart from an end of the precipitation unit 110 in a longitudinal direction of the precipitator body 100. Therefore, the particulate discharge fluid supply area 120-1 may be in communication with the precipitating area 110-1. For example, the supply area forming member 121 may be connected to the discharge guide unit 130 in a state where it is disposed apart from an upper end of the precipitation unit 110. The particulate discharge fluid supply path 122 may be connected to the particulate discharge fluid supply source. Further, the particulate discharge fluid supply path 122 may be connected to the supply area forming member 121 to be in communication with the particulate discharge fluid supply area 120-1. The particulate discharge fluid supply path 122 is connected to the supply area forming member 121 in a circumferential direction of the particulate discharge fluid supply unit 120 so that the particulate discharge fluid can circulate in the particulate discharge fluid supply area 120-1 and the precipitating area 110-1.

The discharge guide unit 130 may guide that the purified gas, whose particulates have been removed in the precipitation unit 110 and which has been flowing in the particulate discharge fluid supply unit 120, to be discharged. The discharge guide unit 130 may be connected to the particulate discharge fluid supply unit 120. In the discharge guide unit 130, there may be formed a discharge guide area 130-1 which forms a portion of the gas processing area 100-1 and is in communication with the precipitating area 110-1. For example, the discharge guide unit 130 has a hollow tubular shape to form the discharge guide area 130-1. A portion of the electrode connecting member 400 may be disposed in the discharge guide area 130-1. The insulation device 300 may be connected to the discharge guide unit 130 such that the discharge guide area 130-1 can be in communication with an insulating area 300-1, which is to be described below, formed in the insulation device 300. The discharge guide unit 130 may comprise a discharge guide area forming member 131 and a guide area cleaning fluid spray nozzle 132.

The discharge guide area forming member 131 may form the discharge guide area 130-1 and be connected to the particulate discharge fluid supply unit 120. The discharge guide area forming member 131 has a hollow tubular shape to form the discharge guide area 130-1. Further, a gas discharge hole from which the purified gas is discharged, and a communication hole communicating with the insulating area 300-1 of the insulation device 300 may be formed in the discharge guide area forming member 131. For example, the gas discharge hole may be formed on the upper part of the discharge guide area forming member 131 and the communication hole may be formed on the side of the discharge guide area forming member 131.

The guide area cleaning fluid spray nozzle 132 may be connected to a guide area cleaning fluid supply source and spray the guide area cleaning fluid to the discharge guide area 130-1. For example, the guide area cleaning fluid sprayed by the guide area cleaning fluid spray nozzle 132 may be water. In this case, the guide area cleaning fluid supply source may be identical to an insulator cleaning fluid supply source which is to be described below.

The discharge electrode 200 may generate corona discharge that charges the particulates contained in the waste gas flowing in the gas processing area 100-1 of the precipitator body 100. The corona discharge may be generated between the discharge electrode 200 and the precipitator body 100. The discharge electrode 200 may be disposed in the gas processing area 100-1 to be spaced apart from the precipitator body 100. The discharge electrode 200 may be disposed in the center of the precipitating area 110-1 of the gas processing area 100-1. The discharge electrode 200 may be connected to a power source. The discharge electrode 200 may be connected to a cathode or an anode of high voltage power source via the electrode connecting member 400. The discharge electrode 200 may comprise an electrode body 210 and discharge pins 220.

The electrode body 210 may be disposed in the center of the precipitating area 110-1 of the gas processing area 100-1 in the precipitator body 100. The electrode body 210 may have a tubular shape whose hollow interior is closed. One side of the electrode body 210 may be pointed. Further, the other side of the electrode body 210 may be flat. For example, the lower part of the electrode body 210 may be pointed and the upper part of the electrode body 210 may be flat. The flat upper part of the electrode body 210 may be connected to the electrode connecting member 400. A plurality of the discharge pins 220 may extend in a radial direction from the electrode body 210. As corona discharge is generated between the discharge pins 220 and the precipitator body 100, the particulates contained in the waste gas flowing between the discharge electrode 200 and the precipitator body 100 may be charged.

The insulation device 300 may support the electrode connecting member 400 which is connected to the discharge electrode 200 such that it is connected to the power source and may insulate a portion of the electrode connecting member 400. The corona discharge may occur between the discharge electrode 200 and the precipitator body 100 due to the insulation device 300 insulating the portion of the electrode connecting member 400. The insulation device 300 may comprise an insulation device body 310, an insulation device cover 320, an insulator 330, and an insulating area cleaning fluid spray nozzle 340.

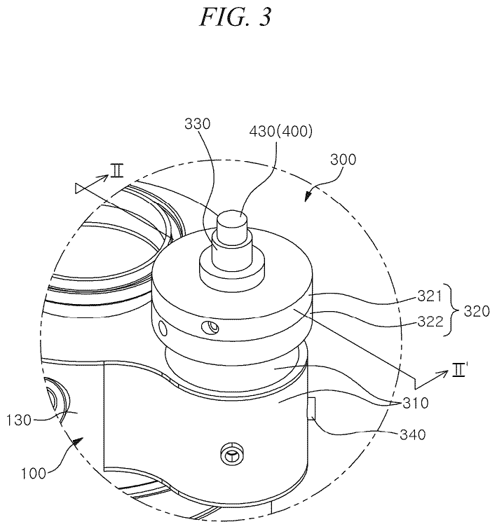

As shown in FIGS. 3 to 6, the insulating area 310-1 may be formed in the insulation device body 310, and the insulation device body 310 may be connected to the precipitator body 100 so that one open side of the insulating area 310-1 is in communication with the interior of the precipitator body 100. For example, the upper part and a portion of the side of the insulating area 310-1 may be open. Further, the insulation device body 310 may be connected to the discharge guide unit 130 of the precipitator body 100 so that the open side portion of the insulating area 310-1 is in communication with the discharge guide area 130-1 of the gas processing area 100-1 in the precipitator body 100. In addition, at least a portion of the insulation device body 310 may be integral with the discharge guide unit 130 to be connected to the discharge guide unit 130.

The insulation device cover 320 may support the electrode connecting member 400. The insulation device cover 320 may be connected to the insulation device body 310 to close the other open side of the insulating area 310-1. For example, the insulation device cover 320 may be connected to the insulation device body 310 to close the open upper part of the insulating area 310-1. The insulation device cover 320 may be configured to spray, onto the insulator 330, one or more of an insulator contamination prevention fluid for preventing contamination of a surface of the insulator 330, an insulator cleaning fluid for cleaning a surface of the insulator 330, and an insulator drying fluid for drying a surface of the insulator 330. The insulation device cover 320 may comprise a first fluid spray cover 321 and a second fluid spray cover 322.

The first fluid spray cover 321 may be configured to allow the insulator 330 to pass therethrough, and to spray one or more of the insulator contamination prevention fluid, the insulator cleaning fluid, and the insulator drying fluid along a circumference of the insulator 330, in an angle with a longitudinal direction of the insulator 330. The first fluid spray cover 321 may be formed with a first fluid supply path 321-1, a fluid flowing area 321-2, and a fluid spray outlet 321-3. Additionally, the first fluid spray cover 321 may comprise a first spray cover main part 321-4 and a first spray cover auxiliary part 321-5.

The first fluid supply path 321-1 may be connected to the insulator contamination prevention fluid supply source, the insulator cleaning fluid supply source, and the insulator drying fluid supply source. The insulator contamination prevention fluid and the insulator drying fluid may be identical. In addition, the insulator contamination prevention fluid supply source and the insulator drying fluid supply source may be identical. For example, the insulator contamination prevention fluid and the insulator drying fluid may be nitrogen or compressed dry air. Further, the insulator cleaning fluid may be water. For instance, the first fluid supply path 321-1 may be connected to the insulator contamination prevention fluid supply source and the insulator drying fluid supply source by a first supply pipe 2 on which a first supply valve 3 is disposed. Further, the first fluid supply path 321-1 may be connected to the insulator cleaning fluid supply source by a second supply pipe 4 on which a second supply valve 5 is disposed. The second supply pipe 4 may be connected to the first supply pipe 2 to be connected to the first fluid supply path 321-1.

The first fluid supply path 321-1 may be formed to be parallel to a virtual line VL passing the center of a transverse cross-section of the insulator 330, which is a cross-section of the insulator 330 perpendicular to the longitudinal direction of the insulator 330, and to be spaced apart from the virtual line VL to one side or the other side. For example, there may be two first fluid supply paths 321-1. In addition, one of the two first fluid supply paths 321-1 may be formed to be spaced apart from the virtual line VL to one side, and the other one formed to be spaced apart from the virtual line VL to the other side. Further, a flow direction of the fluid in the first fluid supply path 321-1 formed to be spaced apart from the virtual line VL to one side may be opposite from a flow direction of the fluid in the first fluid supply path 321-1 formed to be spaced apart from the virtual line VL to the other side. Therefore, the insulator contamination prevention fluid, the insulator cleaning fluid, or the insulator drying fluid supplied to the fluid flowing area 321-2 through the first fluid supply path 321-1 may circulate around the insulator 330 in the fluid flowing area 321-2.

The fluid flowing area 321-2 is connected to the first fluid supply path 321-1 and one or more of the insulator contamination prevention fluid, the insulator cleaning fluid, and the insulator drying fluid flow therein. As described above, in the fluid flowing area 321-2, the insulator contamination prevention fluid, the insulator cleaning fluid, or the insulator drying fluid may circulate around the insulator 330. The size of a transverse cross-section of the fluid flowing area 321-2, which is a cross-section of the fluid flowing area 321-2 perpendicular to the longitudinal direction of the insulator 330, may decrease towards the fluid spray outlet 321-3. Thus, the insulator contamination prevention fluid, the insulator cleaning fluid, or the insulator drying fluid that has flown in the fluid flowing area 321-2 may be sprayed through the fluid spray outlet 321-3.

The fluid spray outlet 321-3 may be connected to the fluid flowing area 321-2 and disposed at the circumference of the insulator 330, and may spray one or more of the insulator contamination prevention fluid, the insulator cleaning fluid, and the insulator drying fluid. For example, a transverse cross-section of the fluid spray outlet 321-3, which is a cross-section of the fluid spray outlet 321-3 perpendicular to the longitudinal direction of the insulator 330, may have a ring shape. As described above, the insulator contamination prevention fluid, the insulator cleaning fluid, or the insulator drying fluid may circulate around the insulator 330 in the fluid flowing area 321-2. Therefore, the insulator contamination prevention fluid, the insulator cleaning fluid, or the insulator drying fluid can be sprayed through the fluid spray outlet 321-3 while circulating around the insulator 330. Further, the insulator contamination prevention fluid, the insulator cleaning fluid, or the insulator drying fluid may be sprayed through the fluid spray outlet 321-3 along the circumference of the insulator 330, in an angle with the longitudinal direction of the insulator 330.

The first spray cover main part 321-4, together with the first spray cover auxiliary part 321-5, may form the first fluid spray cover 321. The first spray cover main part 321-4 may be formed with a first through-hole 321-41, the above-described first fluid supply path 321-1, and a first flowing area forming part 321-42. The insulator 330 may pass through the first through-hole 321-41. As the first fluid supply path 321-1 has been described above, its description is referred to the above. The first flowing area forming part 321-42 may form the fluid flowing area 321-2 described above, together with a second flowing area forming part 321-52 formed in the first spray cover auxiliary part 321-5. The first flowing area forming part 321-42 may be formed to surround the first through-hole 321-41 to be spaced apart from the first through-hole 321-41 in a radial direction.

The first spray cover auxiliary part 321-5 may be connected to the first spray cover main part 321-4 to form the first fluid spray cover 321. In the first spray cover auxiliary part 321-5, a fluid spray outlet opening 321-51 and the second flowing area forming part 321-52 may be formed. The fluid spray outlet opening 321-51 may form the fluid spray outlet 321-3 at an end of one side of the first flowing area forming part 321-42 in the longitudinal direction of the insulator 330. For example, the fluid spray outlet opening 321-51 may form the fluid spray outlet 321-3 at the lower end of the first flowing area forming part 321-42. The second flowing area forming part 321-52 may extend towards the first spray cover main part 321-4 from the fluid spray outlet opening 321-21 and may form the fluid flowing area 321-2 together with the first flowing area forming part 321-42. For example, at least a portion of the second flowing area forming part 321-52 may be inserted into the first flowing area forming part 321-42, thereby forming the fluid flowing area 321-2. The size of a transverse cross-section of the second flowing area forming part 321-52, which is a cross-section of the second flowing area forming part 321-52 perpendicular to the longitudinal direction of the insulator 330, may decrease towards the fluid spray outlet 321-3.

The second fluid spray cover 322 may be connected to the first fluid spray cover 321 and the insulation device body 310 to close the other open side of the insulating area 310-1 together with the first fluid spray cover 321, and the insulator 330 may pass through the second fluid spray cover 322. In addition, the second fluid spray cover 322 may be configured to spray one or more of the insulator contamination prevention fluid, the insulator cleaning fluid, and the insulator drying fluid at the circumference of the insulator 330, in an angle with a circumferential direction of the insulator 330. The second fluid spray cover 322 may be formed with a second fluid supply path 322-1, a fluid flowing path 322-2, and a plurality of fluid spraying paths 322-3. Further, the second fluid spray cover 322 may comprise a second spray cover main part 322-4 and a second spray cover auxiliary part 322-5.

The second fluid supply path 322-1 may be connected to an insulator contamination prevention fluid supply source, an insulator cleaning fluid supply source, and an insulator drying fluid supply source. The contamination prevention fluid supply source, the insulator cleaning fluid supply source and the insulator drying fluid supply source, which the second fluid supply path 322-1 is connected to, may be identical to the insulator contamination prevention fluid supply source, the insulator cleaning fluid supply source and the insulator drying fluid supply source to which the first fluid supply path 321-1 is connected. Further, the insulator contamination prevention fluid and the insulator drying fluid may be identical. In addition, the insulator contamination prevention fluid supply source and the insulator drying fluid supply source may be identical. For example, the insulator contamination prevention fluid and the insulator drying fluid may be nitrogen or compressed dry air. Further, the insulator cleaning fluid supply source may be water. For instance, the second fluid supply path 322-1 may be connected to the insulator contamination prevention fluid supply source and the insulator drying fluid supply source by a third supply pipe 6 on which a third supply valve 7 is disposed. Further, the second fluid supply path 322-1 may be connected to the insulator cleaning fluid supply source by a fourth supply pipe 8 on which a fourth supply valve 9 is disposed. The fourth supply pipe 8 may be connected to the third supply pipe 6 to be connected to the second fluid supply path 322-1.

The second fluid supply path 322-1 may be formed on the virtual line VL passing through the center of the transverse cross-section of the insulator 330, which is the cross-section of the insulator 330 perpendicular to the longitudinal direction of the insulator 330. For example, there may be two second fluid supply paths 322-1. In addition, the two second fluid supply paths 322-1 may be disposed to face each other. Therefore, the flow direction of the fluid flowing in one of the two second fluid supply paths 322-1 may be opposite to the flow direction of the fluid flowing in the other.

The fluid flowing path 322-2 may be connected to the second fluid supply path 322-1 such that one or more of the insulator contamination prevention fluid, the insulator cleaning fluid, and the insulator drying fluid supplied through the second fluid supply path 322-1 can flow therein. For example, a transverse cross-section of the fluid flowing path 322-2, which is a cross-section of the fluid flowing path 322-2 perpendicular to the longitudinal direction of the insulator 330, may have a ring shape. As described above, if the two second fluid supply paths 322-1 are formed to face each other on the virtual line VL passing through the center of the transverse cross-section of the insulator 330, which is the cross-section of the insulator 330 perpendicular to the longitudinal direction of the insulator 330, fluids can flow relatively evenly in the fluid flowing path 322-2.

A plurality of fluid spraying paths 322-3 may be connected to the fluid flowing path 322-2 and disposed along the circumference of the insulator 330, to spray one or more of the insulator contamination prevention fluid, the insulator cleaning fluid, and the insulator drying fluid. The plurality of fluid spraying paths 322-3 may be formed to extend towards the insulator 330 in an angle with the circumferential direction of the insulator 330. Thus, one or more of the insulator contamination prevention fluid, the insulator cleaning fluid, and the insulator drying fluid may be sprayed through the plurality of fluid spraying paths 322-3 in an angle with the circumferential direction of the insulator 330. Further, one or more of the insulator contamination prevention fluid, the insulator cleaning fluid, and the insulator drying fluid may circulate around the insulator 330.

The second spray cover main part 322-4 may be formed with a second through-hole 322-41, the above-described second fluid supply path 322-1, and a flowing path forming part 322-42. The insulator 330 may pass through the second through-hole 322-41. Further, as the second fluid supply path 322-1 has been described above, its description is referred to the above. The flowing path forming part 322-42 may form the fluid flowing path 322-2 described above together with the second spray cover auxiliary part 322-5. The flowing path forming part 322-42 may be formed to surround the second through-hole 322-41 to be spaced apart from the second through-hole 322-41 in a radial direction from.

The second spray cover auxiliary part 322-5 may be formed with a third through-hole 322-51 and the above-described plurality of fluid spraying paths 322-3. The insulator 330 may pass through the third through-hole 322-51. The plurality of fluid spraying paths 322-3 may be formed to be in communication with the third through-hole 322-51. Further, the second spray cover auxiliary part 322-5 may form the fluid flowing path 322-2 together with the flowing path forming part 322-42 of the second spray cover main part 322-4. For example, at least a portion of the second spray cover auxiliary part 322-5 may be inserted into the flowing path forming part 322-42, thereby forming the fluid flowing path 322-2.

The insulator 330 may insulate a portion of the electrode connecting member 400. One side of the insulator 330 may pass through the insulation device cover 320 to be disposed in the insulating area 310-1, and the other side may be disposed outside the insulation device cover 320. For example, the insulator 330 may pass through the first through-hole 321-41, the second through-hole 322-41, and the third through-hole 322-51 of the insulation device cover 320. A portion of the electrode connecting member 400 extending from the interior of the precipitator body 100 to the insulating area 310-1 may pass through the insulator 330 to extend to the outside of the insulation device cover 320. A portion of the electrode connecting member 400 may be insulated by the portion of the electrode connecting member 400 passing through the insulator 330. The insulator 330 may be formed with a member through-hole 331, which the portion of the electrode connecting member 400 passes through. For example, a portion of a third connecting member 430, which is to be described below, comprised in the electrode connecting member 400 may pass through the member through-hole 331 of the insulator 330 to be insulated by the insulator 330. One side of the insulator 330 disposed in the insulating area 310-1 may be spaced apart from the insulation device body 310 so that no insulation breakdown occurs between the insulation device body 310 due to contamination of a surface of the insulator 330. For example, one side of the insulator 330 may be disposed at the center of the insulating area 310-1. Further, the insulator 330 may have a thickness sufficient to insulate a portion of the electrode connecting member 400.

The insulating area cleaning fluid spray nozzle 340 may be connected to an insulating area cleaning fluid supply source and spray an insulating area cleaning fluid to the insulating area 310-1. For example, the insulating area cleaning fluid sprayed from the insulating area cleaning fluid spray nozzle 340 may be water. In this case, the insulating area cleaning fluid supply source may be identical to the insulator cleaning fluid supply source as described above. The insulating area cleaning fluid spray nozzle 340 may be disposed such that a plurality thereof are spaced apart from each other along the circumference of the insulation device body 310. For instance, two insulating area cleaning fluid spray nozzles 340 may be disposed apart from each other along the circumference of the insulation device body 310.

Referring back to FIGS. 1 and 2, the electrode connecting member 400 may support the discharge electrode 200 while connecting the discharge electrode 200 to the power source. One side of the electrode connecting member 400 may be connected to the discharge electrode 200. Further, the other side of the electrode connecting member 400 may pass through the insulation device 300, via a portion of the gas processing area 100-1 of the precipitator body 100 and the insulating area 310-1 of the insulation device 300, to extend to the outside of the insulation device 300 and to be connected to the power source. The electrode connecting member 400 may be connected to a cathode or an anode of a high voltage electrode. The electrode connecting member 400 may comprise a first connecting member 410, a second connecting member 420, and a third connecting member 430.

The first connecting member 410 may be connected to the discharge electrode 200 and extend in a longitudinal direction of the precipitator body 100 from the first connecting member 410. The first connecting member 410 may extend from the discharge electrode 200 to the discharge guide area 130-1 of the precipitator body 100. For example, the first connecting member 410 may extend upward from the discharge electrode 200 to the discharge guide area 130-1.

The second connecting member 420 may be connected to the first connecting member 410 and extend from the first connecting member 410 to the discharge guide area 130-1 of the insulation device 300 via the discharge guide area 130-1 of the precipitator body 100. For example, the second connecting member 420 may extend horizontally from the second connecting member 420 to the insulating area 310-1 of the insulation device 300.

The third connecting member 430 may be connected to the second connecting member 420 in the insulating area 310-1 of the insulation device 300. Further, the third connecting member 430 may extend from the second connecting member 420 to the outside of the insulation device 300, passing through the member through-hole 331 of the insulator 330 in the insulation device 300. The third connecting member 430 extending outside of the insulation device 300 may be connected to the power source. For example, the third connecting member 430 may extend upward from the second connecting member 420 to pass through the member through-hole 331 of the insulator 330 in the insulation device 300, extending to the outside of the insulation device 300 to connect with the cathode or the anode of the high voltage power source.

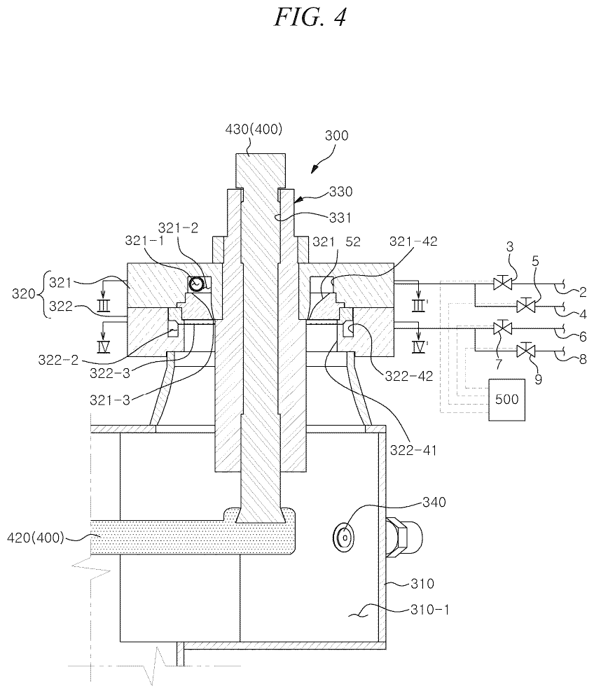

Returning to FIG. 4, the controller 500 may control the supply of the insulator contamination prevention fluid, the insulator cleaning fluid, and the insulator drying fluid to the insulation device cover 320. For instance, the controller 500 may control the above-described first supply valve 3, second supply valve 5, third supply valve 7, and fourth supply valve 9 to control the supply of the insulator contamination prevention fluid, the insulator cleaning fluid, and the insulator drying fluid to the insulation device cover 320. The controller 500 may be included in a wet electrostatic precipitator controller for controlling the wet electrostatic precipitator 1, or may be configured separately from the wet electrostatic precipitator controller. The controller 500 may be implemented by a computing device comprising a microprocessor, a memory, etc., and as its implementation is obvious to those skilled in the art, its detailed explanation is omitted.

The controller 500 may control, in a precipitation mode where the particulate contained in the waste gas is precipitated in the wet electrostatic precipitator 1, the insulator contamination prevention fluid to be sprayed onto the surface of the insulator 330 through the insulation device cover 320. For example, the second supply valve 5 and the fourth supply valve 9 may be closed and the first supply valve 3 and the third supply valve 7 may be opened by the controller 500. Further, nitrogen or compressed dry air, which serves as the insulator contamination prevention fluid, may be sprayed onto the surface of the insulator 330 through the insulation device cover 320.

The controller 500 may control, in an insulator cleaning mode where the surface of the insulator 330 is cleaned, such that the electrical connection between the power and the discharge electrode 200 is blocked. Further, the controller 500 may control the insulator contamination prevention fluid and the insulator cleaning fluid to be sprayed onto the surface of the insulator 330 through the insulation device cover 320. As the insulator contamination prevention fluid and the insulator cleaning fluid are sprayed together through the insulation device cover 320, cleaning of the surface of the insulator 330 can be more efficiently performed. For example, the first supply valve 3, the second supply valve 5, the third supply valve 7, and the fourth supply valve 9 may be opened by the controller 500. In addition, water, which serves as the insulator cleaning fluid, and nitrogen or compressed dry air, which serves as the insulator contamination prevention fluid, may be sprayed onto the surface of the insulator 330 through the insulation device cover 320.

The controller 500 may control, in an insulator drying mode where the surface of the insulator 330 is dried, such that the insulator drying fluid is sprayed onto the surface of the insulator 330 through the insulation device cover 320. For example, the second supply valve 5 and the fourth supply valve 9 may be closed and the first supply valve 3 and the third supply valve 7 may be opened by the controller 500. Further, nitrogen or compressed dry air, which serves as the insulator drying fluid, may be sprayed onto the surface of the insulator 330 through the insulation device cover 320.

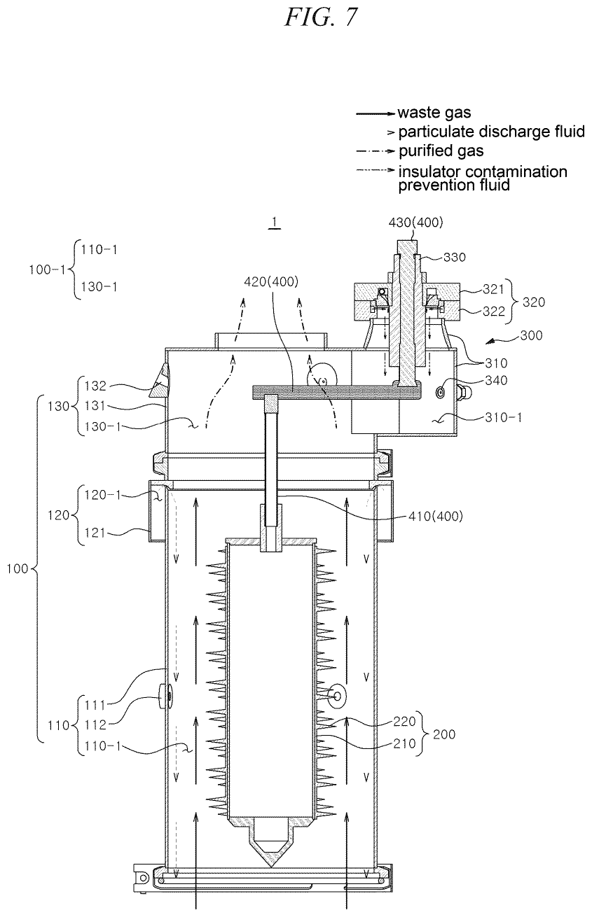

Hereinafter, with reference to FIGS. 7 to 10, the operation and effects of the insulation device with the above-described configurations and the wet electrostatic precipitator having the same will be explained.

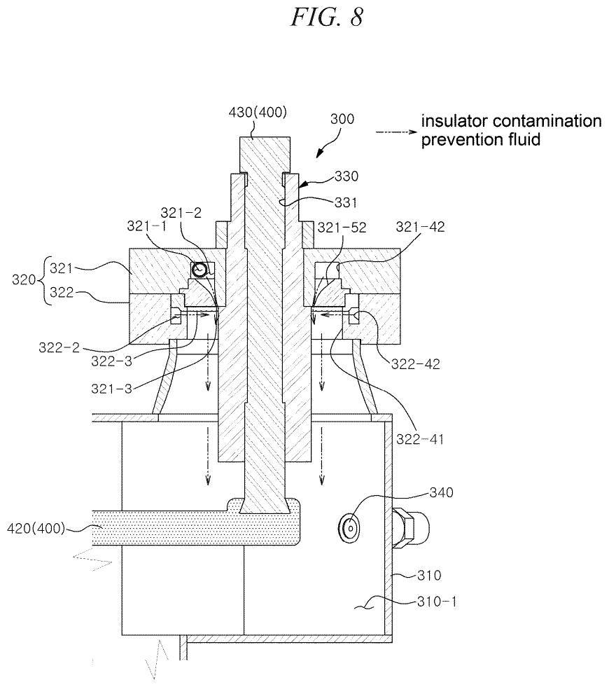

According to FIGS. 7 and 8, in the precipitation mode, the discharge electrode 200 may be electrically connected to the high voltage power source via the electrode connecting member 400. Additionally, the particulate discharge fluid may flow on the inner surface of the wet electrostatic precipitator 1. Further, the waste gas may enter the wet electrostatic precipitator 1. In a state in which the discharge electrode 200 is electrically connected to the power source, when the waste gas enters the wet electrostatic precipitator 1, the particulates contained in the waste gas are charged, and the charged particulates may be precipitated on the inner surface of the wet electrostatic precipitator 1. The particulates precipitated on the inner surface of the wet electrostatic precipitator 1 may be discharged from the wet electrostatic precipitator 1 by the particulate discharge fluid. Further, the purified gas, which is the waste gas from which the particulates have been removed, may be discharged from the wet electrostatic precipitator 1.

Meanwhile, in the insulation device 300, by the control of the controller 500, the insulator contamination prevention fluid may be sprayed onto the insulator 330 through the insulation device cover 320. As such, the contamination of the surface of the insulator 330 by the particulates which have not been removed and are still contained in the purified gas that has flown to the insulation device 300 attaching to the surface of the insulator 330 can be prevented.

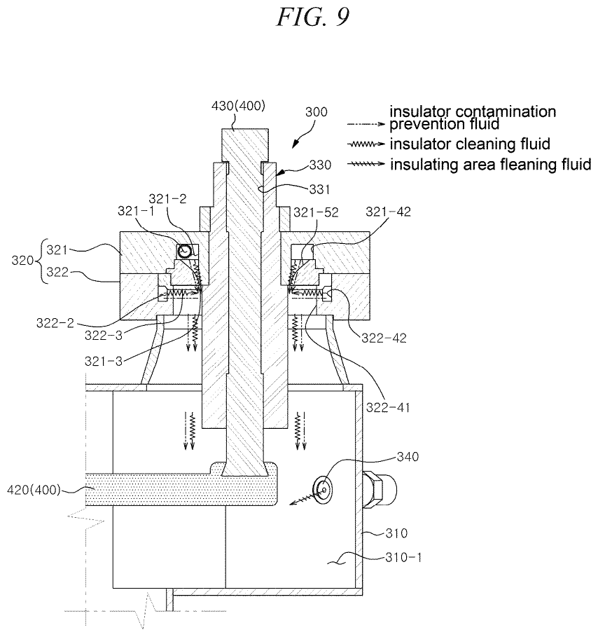

Referring to FIG. 9, in the insulator cleaning mode, the electrical connection between the power source and the discharge electrode 200 may be blocked first by the controller 500. After the electrical connection between the power source and the discharge electrode 200 is blocked, by the control of the controller 500, not only the insulator contamination prevention fluid but also the insulator cleaning fluid may be sprayed onto the insulator 330, through the insulation device cover 320. Therefore, the particulates attached to the surface of the insulator 330 can be cleaned. In the insulator cleaning mode, the insulating area cleaning fluid may be sprayed to the insulating area 310-1 from the insulating area cleaning fluid spray nozzle 340. Further, in the insulator cleaning mode, the guide area cleaning fluid may be sprayed to the discharge guide area 130-1 from the guide area cleaning fluid spray nozzle 132.

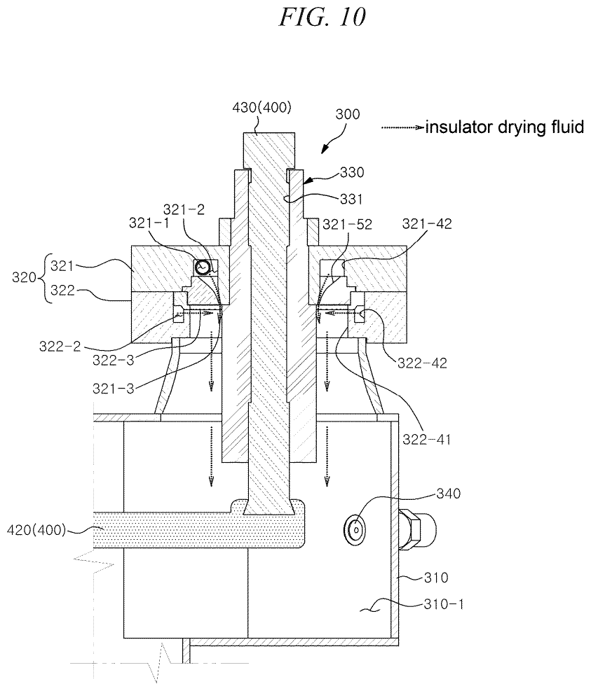

According to FIG. 10, in the insulator drying mode, by the control of the controller 500, the insulator drying fluid may be sprayed onto the insulator 330, through the insulation device cover 320, allowing the surface of the insulator 330 to dry. After a certain time period after the insulator drying fluid is sprayed onto the insulator 330 through the insulation device cover 320, the power source and the discharge electrode 200 may be electrically connected with each other, by the control of the controller 500.

The insulator cleaning mode and the insulator drying mode can be periodically or non-periodically performed. For example, if the precipitation mode is carried out for one hour, the insulator cleaning mode and the insulator drying mode are carried out for four minutes, respectively.

As such, in the precipitation mode, as the insulator contamination prevention fluid is sprayed onto the insulator 330 through the insulation device cover 320, the invention achieves an effect of preventing contamination of the surface of the insulator 330 in the precipitation mode. In addition, in the periodic or non-periodic insulator cleaning mode and the insulator drying mode, through the insulation device cover 320, the insulator contamination prevention fluid and the insulator cleaning fluid are sprayed onto the insulator 330 to clean the insulator 330, and the insulator drying fluid is sprayed to dry the insulator 330. Thus, the invention achieves an effect of minimizing the contamination of the surface of the insulator 330. Further, the invention also achieves an effect of increasing the operation time of the wet electrostatic precipitator 1 by minimizing insulation breakdown and high voltage short circuit due to the contamination of the surface of the insulator 330 in the wet electrostatic precipitator 1.

The presently disclosed embodiments are considered in all respect to be illustrative and not restrictive, and should be construed to have the broadest scope according to the technical concept disclosed herein. The above-described embodiments can be embodied in various forms. Further, the above-described embodiment may be omitted, replaced, or changed in various forms without departing from the scope of the appended claims and the gist thereof, and it is obvious that these various modifications and alternatives to the disclosed embodiments should fall within the scope of the invention.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An insulation device, comprising:
an insulation device body forming an insulating area, the insulation device body being connected to a wet electrostatic precipitator such that one open side of the insulating area is in communication with an interior of the wet electrostatic precipitator;
an insulation device cover connected to the insulation device body to close the other open side of the insulating area; and
an insulator passing through the insulation device cover such that one side of the insulator is disposed in the insulating area and the other side thereof is disposed outside the insulation device cover, a portion of an electrode connecting member which extends from the interior of the wet electrostatic precipitator to the insulating area passing through the insulator, the insulator extending to the outside of the insulation device cover to insulate a portion of the electrode connecting member,
wherein the insulation device cover is configured to spray, onto the insulator, at least one of an insulator contamination prevention fluid for preventing contamination of a surface of the insulator, an insulator cleaning fluid for cleaning a surface of the insulator, and an insulator drying fluid for drying a surface of the insulator.

2. The insulation device according to claim 1, wherein the insulation device cover comprises a first fluid spray cover through which the insulator passes, the first fluid spray cover being configured to spray at least one of the insulator contamination prevention fluid, the insulator cleaning fluid, and the insulator drying fluid along a circumference of the insulator, in an angle with a longitudinal direction of the insulator.

3. The insulation device according to claim 2, the first fluid spray cover comprising:
a first fluid supply path connected to an insulator contamination prevention fluid supply source, an insulator cleaning fluid supply source, and an insulator drying fluid supply source;
a fluid flowing area connected to the first fluid supply path, at least one of the insulator contamination prevention fluid, the insulator cleaning fluid, and the insulator drying fluid supplied through the first fluid supply path flowing in the fluid flowing area; and
a fluid spray outlet disposed at the circumference of the insulator so as to be in communication with the fluid flowing area, the fluid spray outlet being configured such that at least one of the insulator contamination prevention fluid, the insulator cleaning fluid, and the insulator drying fluid is sprayed therethrough.

4. The insulation device according to claim 3, wherein the first fluid supply path is formed to be parallel to a virtual line passing a center of a transverse cross-section of the insulator and to be spaced apart from the virtual line to one side or the other side, the transverse cross-section being a cross-section of the insulator perpendicular to the longitudinal direction of the insulator.

5. The insulation device according to claim 3, wherein the size of a transverse cross-section of the fluid flowing area, which is a cross-section of the fluid flowing area perpendicular to the longitudinal direction of the insulator, decreases towards the fluid spray outlet.

6. The insulation device according to claim 3, the first fluid spray cover comprising:
a first spray cover main part including a first through-hole through which the insulator passes, the first fluid supply path, and a first flowing area forming part spaced apart from the first through-hole in a radial direction and surrounding the first through-hole; and
a first spray cover auxiliary part including a fluid spray outlet opening which forms the fluid spray outlet between one end of the first flowing area forming part in the longitudinal direction of the insulator, and a second flowing area forming part extending from the fluid spray outlet opening towards the first spray cover main part so as to form the fluid flowing area together with the first flowing area forming part.

7. The insulation device according to claim 2, the insulation device cover further comprising a second fluid spray cover connected to the first fluid spray cover and the insulation device body to close the other open side of the insulating area together with the first fluid spray cover, the insulator passing through the second fluid spray cover, the second fluid spray cover being configured to spray at least one of the insulator contamination prevention fluid, the insulator cleaning fluid, and the insulator drying fluid around the insulator, in an angle with a circumferential direction of the insulator.

8. The insulation device according to claim 7, the second fluid spray cover comprising:
a second fluid supply path connected to an insulator contamination prevention fluid supply source, an insulator cleaning fluid supply source, and an insulator drying fluid supply source;
a fluid flowing path connected to the second fluid supply path, at least one of the insulator contamination prevention fluid, the insulator cleaning fluid, and the insulator drying fluid supplied through the second fluid supply path flowing in the fluid flowing path; and
a plurality of fluid spraying paths connected to the fluid flowing path and disposed along the circumference of the insulator, the plurality of fluid spraying paths spraying at least one of the insulator contamination prevention fluid, the insulator cleaning fluid, and the insulator drying fluid.

9. The insulation device according to claim 8, wherein the fluid spraying paths extend towards the insulator in an angle with the circumferential direction of the insulator.

10. The insulation device according to claim 8, the second fluid spray cover comprising:
a second spray cover main part including a second through-hole through which the insulator passes, the second fluid supply path, and a flowing path forming part spaced apart from the second through-hole in a radial direction and surrounding the second through-hole; and
a second spray cover auxiliary part including a third through-hole which the insulator passes through and the plurality of fluid spraying paths are formed to be in communication with, the second spray cover auxiliary part forming the fluid flowing path together with the flowing path forming part.

11. A wet electrostatic precipitator, comprising:
a precipitator body which is grounded and formed with a gas processing area, wherein a waste gas containing particulates enters and flows in the gas processing area and a purified gas, which is the waste gas from which the particulates have been removed, is discharged from the gas processing area;
a discharge electrode disposed in the gas processing area to be spaced apart from the precipitator body;
an insulation device formed with an insulating area and connected to the precipitator body such that one open side of the insulating area is in communication with the gas processing area; and
an electrode connecting member whose one side is connected to the discharge electrode and the other side passes through the insulation device via a portion of the gas processing area and the insulating area, the electrode connecting member extending outside of the insulation device to be connected to a power source,
wherein the insulation device comprises an insulator, which a portion of the electrode connecting member passes through, to insulate the portion of the electrode connecting member, and
wherein the insulation device is configured to spray, onto the insulator, at least one of an insulator contamination prevention fluid for preventing contamination of a surface of the insulator, an insulator cleaning fluid for cleaning a surface of the insulator, and an insulator drying fluid for drying a surface of the insulator.

12. The wet electrostatic precipitator according to claim 11, the insulation device further comprising:
an insulation device body formed with the insulating area; and
an insulation device cover connected to the insulation device body to close the other open side of the insulating area,
wherein the insulator passes through the insulation device cover so that one side of the insulator is disposed in the insulating area and the other side thereof is disposed outside of the insulation device cover, and
wherein the insulation device cover is configured to spray, onto the insulator, at least one of the insulator contamination prevention fluid, the insulator cleaning fluid, and the insulator drying fluid.

13. The wet electrostatic precipitator according to claim 12, further comprising a controller for controlling the supply of the insulator contamination prevention fluid, the insulator cleaning fluid, and the insulator drying fluid to the insulation device cover,
wherein the controller controls:
in a precipitation mode where the particulates contained in the waste gas is precipitated in the wet electrostatic precipitator, the insulator contamination prevention fluid to be sprayed onto a surface of the insulator through the insulation device cover;
in an insulator cleaning mode where a surface of the insulator is cleaned, the insulator contamination prevention fluid and the insulator cleaning fluid to be sprayed onto a surface of the insulator through the insulation device cover while blocking an electrical connection between the power source and the discharge electrode; and
in an insulator drying mode where a surface of the insulator is dried, the power source and the discharge electrode to be electrically connected with each other after the insulator drying fluid is sprayed onto a surface of the insulator.
